(19) United States
(12) Patent Application Publication
(10) Pub. No.: US 2009/0043792 A1
(43) Pub. Date: Feb. 12, 2009

(54) Partial Compression of a Database Table Based on Historical Information

(76) Inventors: Eric Lawrence Barsness, Pine Island, MN (US); John Matthew Santosuosso, Rochester, MN (US)

Correspondence Address: MARTIN & ASSOCIATES, LLC, P.O. BOX 548, CARTHAGE, MO, 64836-0548, US

(21) Appl. No.: 11/834,837

(22) Filed: Aug. 7, 2007

(51) Int. Cl. G06F 7/00

(52) U.S. Cl. 707/101

(57) ABSTRACT

A database partial compression mechanism compresses only part of a database table based on historical information regarding how the database table has been accessed in the past. The function of the database partial compression mechanism may also be governed by a user-specified partial compression policy. When the historical information indicates a portion of a table is not frequently used, the portion of the table is compressed without compressing other portions of the table. The result is a table that is uncompressed for portions that are accessed often and compressed for portions that are accessed less often.

### CROSS-REFERENCE TO RELATED APPLICATIONS

This patent application is related to the following U.S. patent applications: “PARALLEL UNCOMPRESSION OF A PARTIALLY COMPRESSED DATABASE TABLE”, Ser. No. ______, filed on ______; and “DYNAMIC PARTIAL UNCOMPRESSION OF A DATABASE TABLE”, Ser. No. ______, filed on ______. Both of these related patent applications are incorporated herein by reference.

### BACKGROUND

1. Technical Field

This disclosure generally relates to computer systems, and more specifically relates to database systems.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database. Retrieval of information from a database is typically done using queries. A database query typically includes one or more predicate expressions interconnected with logical operators.

Database compression has been known for some time as a way to reduce the size of a table that is not often used. In the prior art, if compression is performed, it is performed on an entire database table. If the data in the table is then needed, the entire table must be uncompressed, then a query may be executed to access data in the table. The cost in processor overhead of compressing and uncompressing a database table can be significant, especially for large tables. For this reason, compression/uncompression schemes have typically been limited to applications when the likelihood of needing data that has been compressed is low. Without a way to achieve some of the performance advantages of compression without having to compress and uncompress an entire database table, compression will remain a little-used tool in databases.

### BRIEF SUMMARY

A database partial compression mechanism compresses only part of a database table based on historical information regarding how the database table has been accessed in the past. The function of the database partial compression mechanism may also be governed by a user-specified partial compression policy. When the historical information indicates a portion of a table is not frequently used, the portion of the table is compressed without compressing other portions of the table. The result is a table that is uncompressed for portions that are accessed often and compressed for portions that are accessed less often.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that performs partial compression of one or more portions of a database table based on historical information regarding how the table has been used in the past;

FIG. 2 is a flow diagram of a prior art method for compressing an entire database table;

FIG. 3 is a flow diagram of a prior art method for processing a query;

FIG. 4 is a flow diagram of a method for compiling historical information when queries are processed;

FIG. 5 is a block diagram of a method for compressing one or more portions of a database table based historical usage information and based on a partial compression policy specified by a user;

FIG. 6 is a sample customerLog table for illustrating one specific example;

FIG. 7 is sample Query History Table showing two queries that were executed in the past that reference the customerLog table 600 in FIG. 6;

FIG. 8 is a sample Decision Info Table showing the tables and columns referenced by the queries in FIG. 7;

FIG. 9 is a sample display for a user to define a partial compression policy;

FIG. 10 is a method for purging historical information according to a specified criteria;

FIG. 11 is a method showing one specific implementation for step 540 of FIG. 5;

FIG. 12 is a method for performing partial compression of a database table to achieve IO savings;

FIG. 13 is a method for reordering data in a database table to achieve IO savings; and

FIG. 14 is a method for compressing one or more partitions of a partitioned database table.

### DETAILED DESCRIPTION

The claims and disclosure herein provide a way to compress one or more portions of a database table according to historical information regarding how the database table has been used in the past, and according to an optional user-specified partial compression policy. When the historical information indicates a portion of a table has been used less frequently than other portions of the table, one or more portions of the table are compressed without compressing other portions of the table. The result is a table that is uncompressed for portions that are accessed more frequently and compressed for portions that are accessed less frequently.

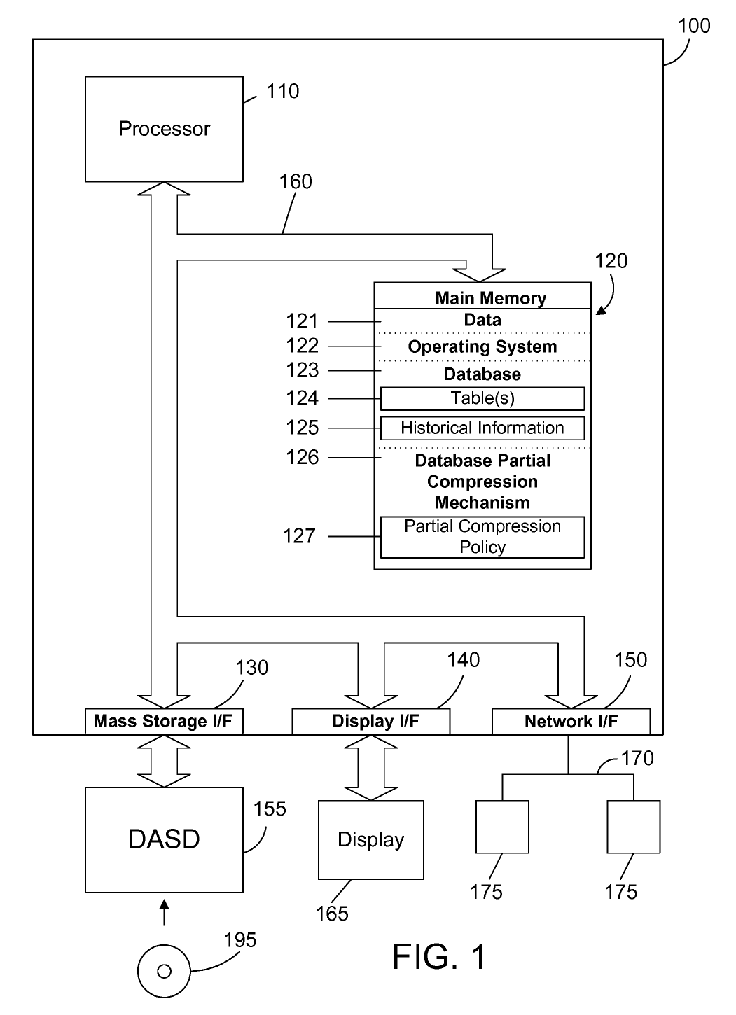

Referring to FIG. 1, a computer system 100 is one suitable implementation of a computer system that includes a database partial compression mechanism that compresses a portion of a database table without compressing all of the database table. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, a database 123, and a database partial compression mechanism 126. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Database 123 is any suitable database, whether currently known or developed in the future. Database 123 preferably includes one or more tables 124 and historical information 125. The historical information 125 contains information that indicates how one or more tables 124 have been accessed in the past. One specific implementation for the historical information 125 is a log of executed queries. Historical information 125 is shown in FIG. 1 to reside within the database 123 because database 123, as it executes queries, preferably logs the historical information 125. Note, however, that historical information 125 could also reside external to the database 123, and could be collected or generated by a mechanism external to the database 123 that monitors database activity.

The database partial compression mechanism 126 performs partial compression of a table 124 in the database according to the historical information 125. In addition, an optional user-specified partial compression policy 127 may also govern how the database partial compression mechanism 126 functions. The database partial compression mechanism 126 preferably compresses at least one portion of a database table without compressing all of the database table according to the historical information 125 that indicates how the database table has been accessed in the past. Thus, portions of a table that are accessed frequently may remain uncompressed, while portions that are accessed less frequently may be compressed by the database partial compression mechanism 126. The user may somewhat control the function of the database partial compression mechanism 126 by specifying one or more parameters in the partial compression policy 127 that determine how the database partial compression mechanism compresses portions of a database table. Note that any suitable compression scheme may be used, whether currently known or developed in the future.

The portions of a database table that may be compressed by the database partial compression mechanism 126 may vary. One suitable example of a portion of a database table that may be compressed is a column. Another suitable example of a portion of a database table that may be compressed is part of a column. For example, if the historical information shows that only the first ten characters of a 200 character string are accessed, the last 190 characters could be compressed while the first ten characters remain uncompressed. Yet another suitable example of a portion of a database table that may be compressed is one or more rows. By selectively compressing portions of a database table while keeping other portions of the table uncompressed, a database system may benefit from compressing portions of a table that are rarely accessed while keeping other portions that are more frequently accessed uncompressed.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, and database partial compression mechanism 126 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that a database partial compression mechanism may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

At this point, it is important to note that while the description above is in the context of a fully functional computer system, those skilled in the art will appreciate that the database partial compression mechanism may be distributed as an article of manufacture in a variety of forms, and the claims extend to all suitable types of computer-readable media that bear instructions that may be executed by a computer. Examples of suitable computer-readable media include recordable media such as floppy disks and CD-RW (e.g., 195 of FIG. 1).

The database partial compression mechanism may also be delivered as part of a service engagement with a client corporation, nonprofit organization, government entity, internal organizational structure, or the like. This may include configuring a computer system to perform some or all of the methods described herein, and deploying software, hardware, and web services that implement some or all of the methods described herein. This may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

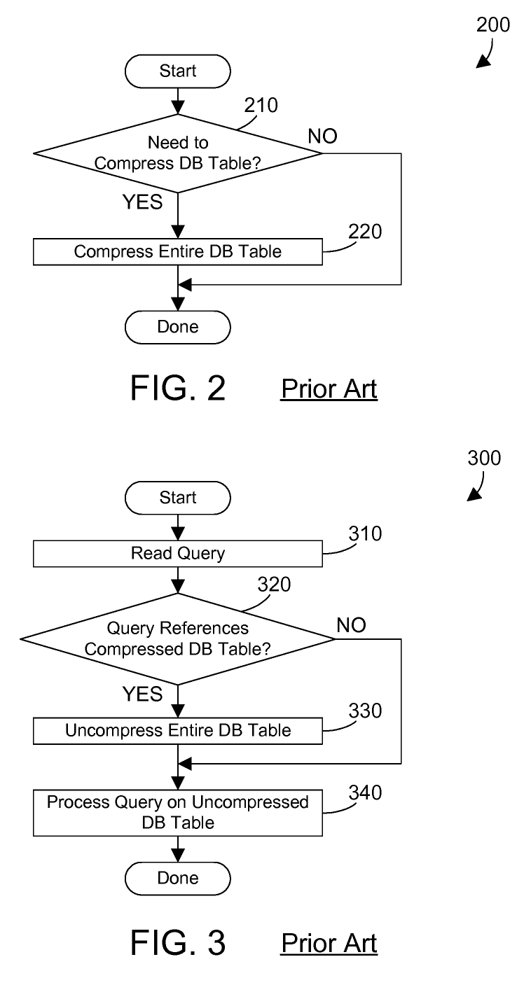

Referring to FIG. 2, a flow diagram of a method 200 shows how compression of a database table is performed in the prior art. If there is a need to compress a database table (step 210=YES), the entire database table is compressed (step 220). If there is no need to compress the database table (step 210=NO), the table is not compressed. In the prior art, compression was only done on a table basis. Nowhere does the prior art show compression of a portion of a database table without compressing all of the database table.

Referring to FIG. 3, a flow diagram of a method 300 shows how a query is processed in the prior art. A query is read (step 310). If the query does not reference a compressed database table (step 320=NO), the query is processed on the uncompressed database table (step 340). If the query references a compressed database table (step 320=YES), the entire database table is uncompressed (step 330), and the query is then processed on the uncompressed database table (step 340). FIGS. 2 and 3 illustrate that compression and decompression in a known database is done on a table-by-table basis. If a table needs to be compressed, all portions of the table are compressed. Because of the relatively high processing cost associated with compressing an entire table, then uncompressing the entire table when a query references the table, database compression is typically reserved for those applications when it is relatively unlikely that a table will be used. The result is the benefits of compression are not fully realized when compressing database tables in the prior art.

The database partial compression mechanism disclosed herein allows compressing one or more portions of a database table without compressing all portions of the database table. The partial compression is performed according to historical information such as past query executions. For example, let's assume a database table includes twelve columns, but actual queries that reference the database table only reference eight of the twelve columns on a regular basis, and very seldom or never query the remaining four columns. The four columns that are not frequently accessed may be compressed while leaving uncompressed the remaining eight columns that are accessed more frequently. The result is a database table that is partially compressed according to the historical information regarding past query executions.

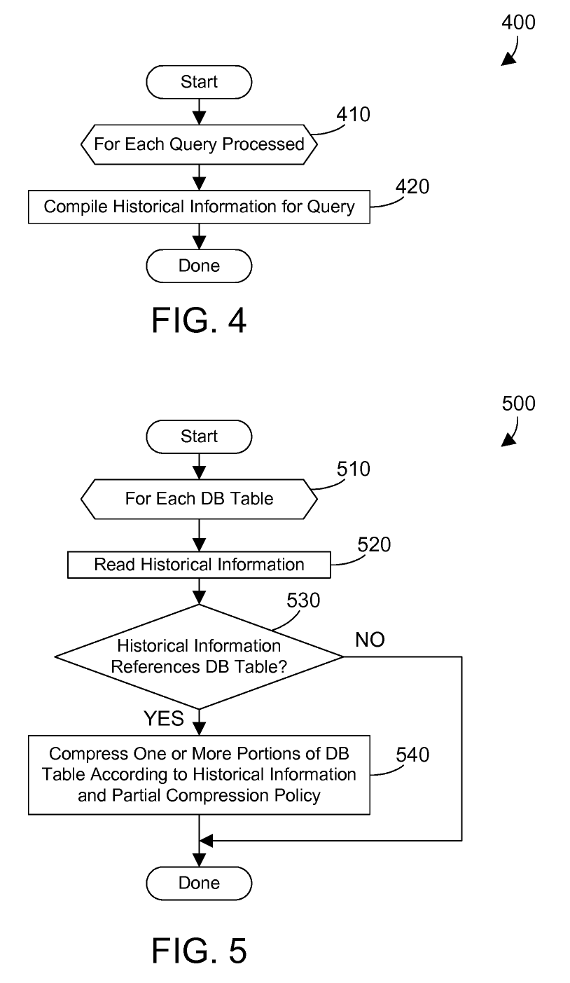

Referring to FIG. 4, a method 400 shows how historical information (e.g., 125 in FIG. 1) may be gathered. For each query processed (step 410), the historical information for the query is compiled (step 420). Note that historical information 125 may include any suitable historical information that may help determine whether or not to partially compress a database table. For example, in one suitable implementation, the historical information 125 includes a separate file for each database table, with the historical information relating to a table being stored in that table's corresponding file. In another example, historical information 125 may include details of all queries executed, along with information regarding which portions of each database table were referenced by each query.

As stated above, the partial compression policy 127 in FIG. 1 is optional, and may be specified by a user to define one or more parameters that determine how the database partial compression mechanism 126 performs compression on a database table. When a partial compression policy 127 has been specified by a user, which portions of the database table are compressed by the database partial compression mechanism depends on both the historical information 125 and the partial compression policy 127.

Method 500 in FIG. 5 shows how the historical information 125 in FIG. 1 and collected in FIG. 4 may be used to compress one or more portions of a database table without compressing all portions of the database table. For each database table (step 510), the historical information is read (step 520). If the historical information does not reference the specific database table of interest (step 530=NO), method 500 is done. If the historical information references the database table (step 530=YES), one or more portions of the database table may be compressed according to the historical information and optionally according to the partial compression policy (step 540).

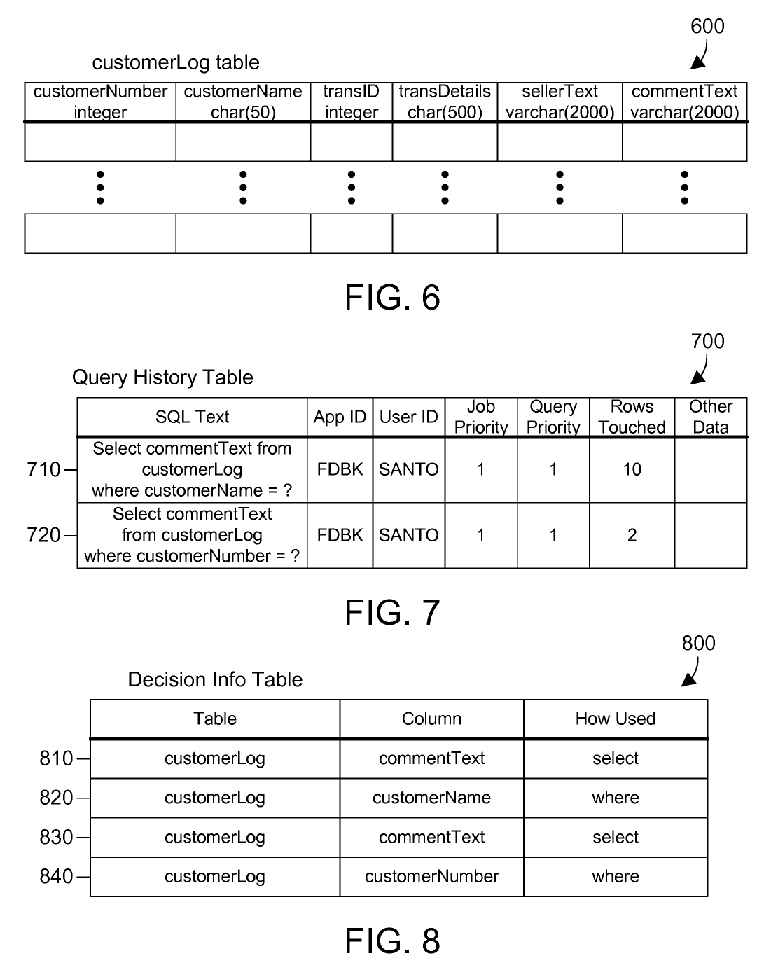

A simple example is now provided to illustrate the concepts discussed in general terms above. Referring to FIG. 6, a table 600 called customerLog includes the following columns: customerNumber, customerName, transID, transDetails, sellerText, and commentText. Table 600 is one suitable example of a database table 124 shown in FIG. 1. Referring to FIG. 7, a sample query history table 700 shows past queries to the customerLog table. The query history table 700 shows the query that was processed in the SQL Text column, the identifier for the application that executed the query in the App ID column, the user ID for the person that ran the application in the User ID column, and data in other columns including job priority, query priority, rows touched, and any other suitable data that relates to the execution of the query. Note that query history table 700 is shown in FIG. 7 to include entries that only relate to a single table, the customerLog table. Note, however, that query history table 700 could also include entries that relate to multiple tables.

A sample decision info table 800 is shown in FIG. 8 that shows information that is determined by processing the information in the query history table 700 in FIG. 7. The decision info table 800 includes a “Table” column that indicates which table is referenced by a database query, a column named “Column” that indicates which column(s) in the table are referenced by the database query, and a “How Used” column that indicates how the column in the table was used in the query. For example, the first entry 710 in table 700 in FIG. 7 results in two entries 810 and 820 in the decision info table 800 that relate to the query in entry 710. The first entry 810 shows the customerLog table is referenced, and the commentText column is referenced in the select statement of the query in entry 710. The second entry 820 shows the customerLog table is referenced, and the customerName column is referenced in the where portion of the query in entry 710. In similar fashion, rows 830 and 840 are derived from processing the query in entry 720 in table 700. Note that both of tables 700 and 800 in FIGS. 7 and 8, respectively, are different forms of historical information 125 in FIG. 1.

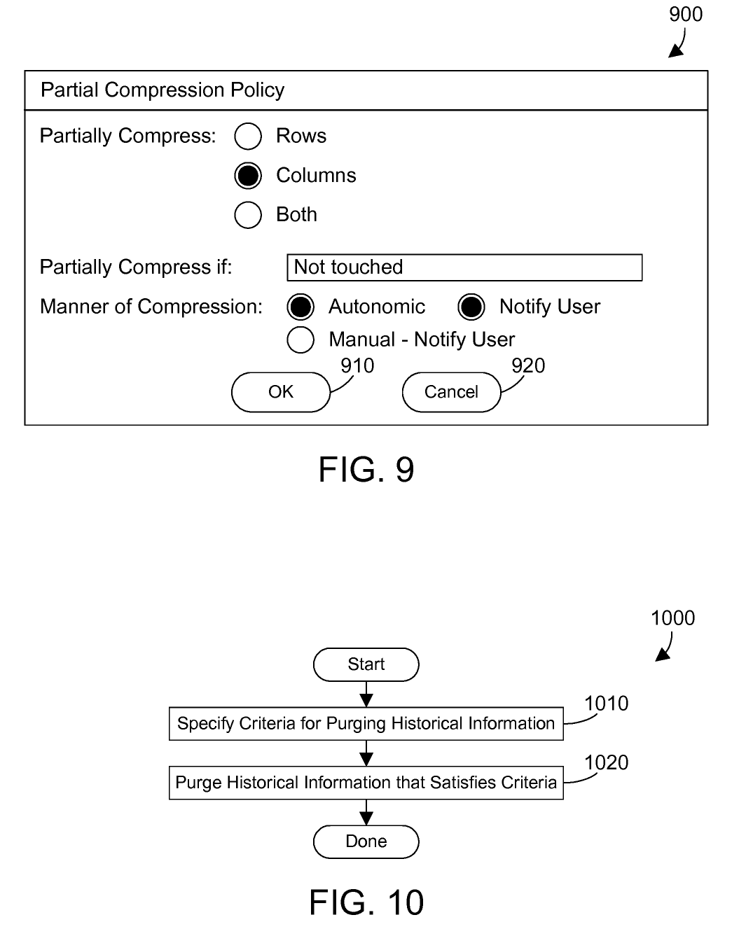

FIG. 9 shows a sample display 900 that may be used by a user to define a partial compression policy 127 in FIG. 1. Display 900 allows a user to select partial compression of rows, columns, or both. In display 900, the user has selected to partially compress if “not touched”, meaning to compress a column if the column is not referenced in any query in the historical information. The user could also specify any suitable threshold or heuristic for determining what to compress. For example, an absolute threshold of 10% could be specified, which would result in portions of the table that are accessed less than 10% of the time to be compressed. A relative threshold of 20% could also be specified, which would result in portions of the database table that are accessed less than 20% of the time other portions of the same table are accessed by a query being compressed. Of course, other suitable thresholds, heuristics could be used to determine what to compress in a database table. The disclosure and claims herein extend to any suitable threshold, criteria or heuristic for determining what portions of a database table to compress or not compress.

Display 900 also shows the user has selected autonomic compression with notification to the user of the autonomic compression. Autonomic compression means the database partial compression mechanism automatically compresses the specified portion of the database based on the historical information when the parameters in the policy are met without user intervention. Notification to the user means the database partial compression mechanism sends notification to the user when a portion of the database is compressed. The display 900 includes an OK button 910 that allows the user to accept the settings in the display 900, and a Cancel button 920 that allows the user to close the partial compression policy window 900 without saving.

We now consider how the database partial compression mechanism 126 in FIG. 1 would function for the simple example in FIGS. 6-9. From examining the decision info table 800 in FIG. 8, we see the columns commentText, customerName and customerNumber are used (or touched) by the queries in the query history table 700 in FIG. 7, but the remaining columns in table 600, namely transID, transDetails, and sellerText have not been touched. The partial compression policy display 900 in FIG. 9 specifies to autonomically compress columns that are not touched. As a result, the database partial compression mechanism compresses the transID, transDetails, and sellerText columns in table 600 in FIG. 6 while leaving the customerNumber, customerName and commentText columns uncompressed.

The disclosure and claims herein relate to any form of historical information. However, maintaining historical information over a long period of time would maintain old information that becomes of little value over time, consuming space in memory and causing longer delays in processing the historical information due to its ever-increasing volume of information. As a result, it is desirable to purge historical information according to some specified criteria to keep the size of the historical information to a manageable level. Referring to FIG. 10, a method 1000 purges historical information. First, criteria for purging historical information is specified (step 1010). The historical information that satisfies the criteria is then purged (step 1020). The criteria can be any suitable criteria for specifying historical information. For example, the criteria could specify a date, and all historical information with a date stamp earlier that the date would be purged. The criteria could specify an application. For example, if an application is removed from a system, all queries called by the application could be purged from the historical information. Of course, many other suitable criteria exist, and the disclosure and claims herein expressly extend to any suitable criteria for purging historical information.

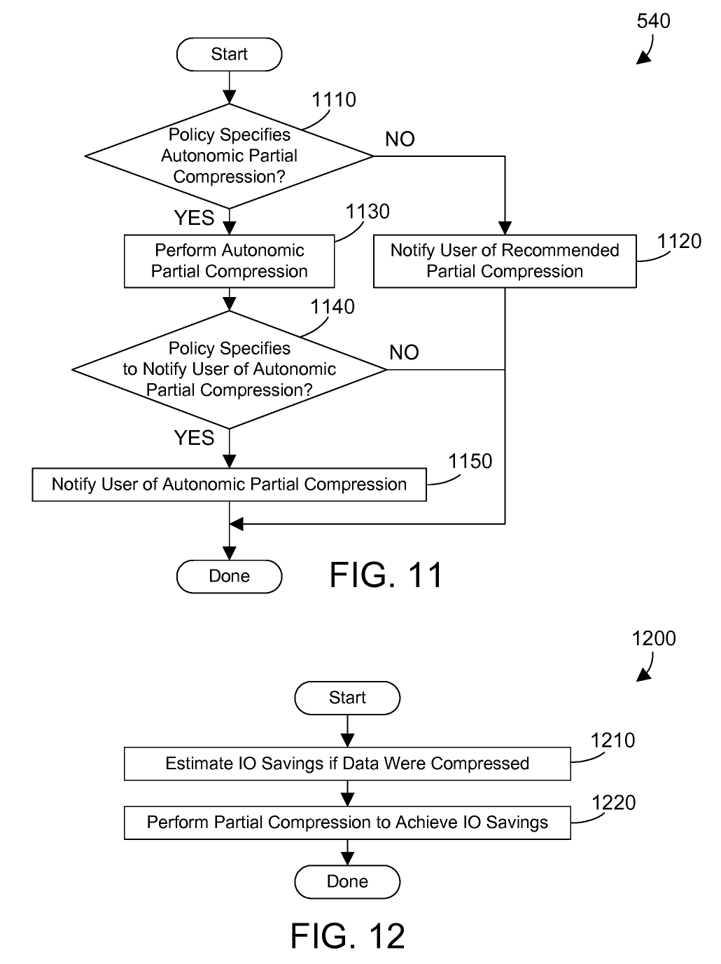

Referring to FIG. 11, a method 540 represents one suitable implementation for step 540 in FIG. 5. If the policy specifies manual partial compression (step 1110=NO), the user is notified of the recommended partial compression (step 1120), and method 540 is done. It is then left to the user to perform the recommended partial compression. If the policy specifies autonomic partial compression (step 1110=YES), the autonomic partial compression is performed (step 1130). If the policy specifies to notify the user of autonomic partial compression (step 1140=YES), the user is notified (step 1150). If the policy specifies not to notify the user of autonomic partial compression (step 1140=NO), method 540 is done. Method 540 shows how a user-defined partial compression policy may be used in conjunction with the historical information in performing partial compression of one or more portions of a database table without compressing all portions of the database table.

Referring to FIG. 12, a method 1200 uses another criteria for determining whether or not to partially compress a database table, namely, whether the compression would result in input/output (IO) savings. The IO savings if the data were compressed is estimated (step 1210). The partial compression is then performed to achieve the estimated I/O savings (step 1220). Note that method 1200 could be implemented within the database partial compression mechanism 126 in making a determination of what portion of a database table to compress.

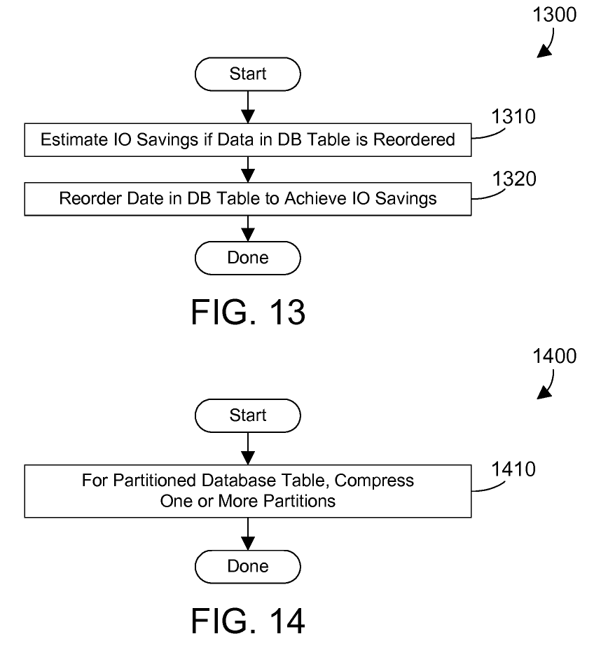

IO savings may also be achieved by reordering data in a database table. Referring to FIG. 13, a method 1300 begins by estimating IO savings if data in the database table is reordered (step 1310). The data in the database table is then reordered to achieve the IO savings (step 1320).

Databases are sometimes partitioned to increase their performance or enhance their reliability. For example, a database table with four columns could be partitioned so that each column is stored in a different partition. If a query only references one of the columns, the query need only be executed on the one database partition for the referenced column, and the other three partitions do not need to execute the query. Partitioned databases are becoming of more and more interest in a massively parallel computer system, such as the BlueGene computer system developed by IBM. When a database is partitioned, the database partial compression mechanism may choose to compress an entire partition while leaving other partitions of the database table uncompressed. Referring to FIG. 14, a method 1400 compresses one or more partitions of a partitioned database table (step 1410). By employing the database partial compression mechanism 126 in a partitioned database, decisions regarding what portions of a database table to compress may be made along partition boundaries. Of course, the database partial compression mechanism 126 could also compress a portion in a partition without compressing all portions in the partition.

The database partial compression mechanism and method disclosed and claimed herein allow compressing one or more portions of a database table without compressing all portions of the database table. Historical information is analyzed to determine which parts of a database table are used less frequently, and one or more portions of the database table that are used less frequently may be compressed. In addition, an optional user-specified partial compression policy may specify one or more parameters that determine how the database partial compression mechanism functions. The result is a database system that allows compressing one or more portions of a database table to increase performance of the database system.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. An apparatus comprising:
at least one processor;
a memory coupled to the at least one processor;
a database table residing in the memory; and
a database partial compression mechanism that compresses at least one portion of the database table and less than all portions of the database table according to historical information regarding how the database table has been used in the past.

2. The apparatus of claim 1 wherein the database partial compression mechanism uses the historical information to compress the at least one portion of the database table that is accessed less frequently than other portions of the database table that remain uncompressed.

3. The apparatus of claim 1 further comprising a user-specified partial compression policy residing in the memory, the partial compression policy specifying at least one parameter that governs how the database table may be partially compressed, wherein the database partial compression mechanism compresses the at least one portion of the database table according to the partial compression policy.

4. The apparatus of claim 1 wherein the at least one portion of the database table that is compressed by the database partial compression mechanism comprises a column in the database table.

5. The apparatus of claim 1 wherein the at least one portion of the database table that is compressed by the database partial compression mechanism comprises a portion of a column in the database table.

6. The apparatus of claim 1 wherein the at least one portion of the database table that is compressed by the database partial compression mechanism comprises a row in the database table.

7. A computer-implemented method for partially compressing a database table, the method comprising the steps of:
(A) collecting historical information regarding how the database table has been used in the past; and
(B) compressing at least one portion of the database table and less than all portions of the database table according to the historical information.

8. The method of claim 7 wherein step (A) comprises the step of collecting the historical information for each query that accesses the database table.

9. The method of claim 7 wherein step (B) uses the historical information to compress the at least one portion of the database table that is accessed less frequently than other portions of the database table that remain uncompressed.

10. The method of claim 7 wherein step (B) is performed according to a user-specified partial compression policy that specifies at least one parameter that governs how the database table may be partially compressed.

11. The method of claim 7 wherein the at least one portion of the database table that is compressed in step (B) comprises a column in the database table.

12. The method of claim 7 wherein the at least one portion of the database table that is compressed in step (B) comprises a portion of a column in the database table.

13. The method of claim 7 wherein the at least one portion of the database table that is compressed in step (B) comprises a row in the database table.

14. A computer-implemented method for partially compressing a database table, the method comprising the steps of:
(A) collecting historical information for each query that accesses the database table;
(B) reading a user-specified partial compression policy that specifies at least one parameter that governs how the database table may be partially compressed; and
(C) compressing at least one portion of the database table and less than all portions of the database table according to the historical information and the user-specified partial compression policy.

15. An article of manufacture comprising:
a database partial compression mechanism that compresses at least one portion of a database table and less than all portions of the database table according to historical information regarding how the database table has been used in the past; and
computer-readable media bearing the database partial compression mechanism.

16. The article of manufacture of claim 15 wherein the database partial compression mechanism uses the historical information to compress the at least one portion of the database table that is accessed less frequently than other portions of the database table that remain uncompressed.

17. The article of manufacture of claim 15 further comprising a user-specified partial compression policy residing in the memory, the partial compression policy specifying at least one parameter that governs how the database table may be partially compressed, wherein the database partial compression mechanism compresses the at least one portion of the database table according to the partial compression policy.

18. The article of manufacture of claim 15 wherein the at least one portion of the database table that is compressed by the database partial compression mechanism comprises a column in the database table.

19. The article of manufacture of claim 15 wherein the at least one portion of the database table that is compressed by the database partial compression mechanism comprises a portion of a column in the database table.

20. The article of manufacture of claim 15 wherein the at least one portion of the database table that is compressed by the database partial compression mechanism comprises a row in the database table.
